(19) United States
(12) Patent Application Publication
(10) Pub. No.: US 2006/0141846 A1
(43) Pub. Date: Jun. 29, 2006

(54) Roll-A-Seal

(76) Inventor: Jon M. Davis, Key Largo, FL (US)

Correspondence Address: JON M. DAVIS, 263 LOEB AVENUE, KEY LARGO, FL, 33037, US

(21) Appl. No.: 11/020,037

(22) Filed: Dec. 23, 2004

(51) Int. Cl. H01R 13/62

(52) U.S. Cl. 439/369

(57) ABSTRACT

A latex rubber cover molded to the base of the plugs on a construction type extension cord. When not in use, it is rolled back like rolling up the sleeve of a long sleeved shirt. When two cords with the latex cover are plugged into each other to make a longer cord, the latex cover on one plug is rolled onto itself and then onto the joined plug. When the cover is fully rolled out covering both plugs tightly, the latex cover on the joined plug is rolled out onto itself and the joined plug and on top of the first latex cover thus giving it a double seal on the joined plugs creating a waterproof joining of two extension cords. This also prevents the two plugs from pulling apart when being extended while being used.

### FIELD OF THE INVENTION

This invention relates to the safer and more convenient use of heavy duty or construction type extension cords when joining two or more extension cords together and using them to power an electrical product such as tools, machinery or lights.

### BACKGROUND OF THE INVENTION

Extension cords are used to expand the working area when working with electrical products. Sometimes they are used in wet environments and this can cause a safety hazard by electrocution. Keeping water away from the exposed electric connections such as extension cord plugs can be difficult. In part, because of this problem Ground Fault Interrupter outlets and breakers were created. When used, Ground Fault Interrupters will trip or stop electric current from flowing to equipment so fast it prevents serious electrical injury. When used in a wet environment, the Ground Fault Interrupter can trip so many times it disrupts the use of electric tools to the point of causing work to stop until drier conditions exist. I created the Roll-A-Seal plug to prevent these problems. This invention makes extension cord connections waterproof. When electric connections are encapsulated by the Roll-A-Seal product, water or other liquids cannot get to the electrical contacts eliminating the safety and convenience problems that can be otherwise experienced.

Electric connections on extension cords are subject to corrosion when they get wet and cords with dampness in the plugs cannot be used when used with Ground Fault Interrupter outlets. These cords must be allowed to dry thoroughly before again being used when Ground Fault Interrupter outlets are being used. This can take several days and can cause the necessity of having many extension cords on hand. Roll-A-Seal was designed to prevent these problems. When two or more extension cords are being used, to prevent the cord plugs from pulling apart and separating, they are often tied together by various means. Sometimes this puts a strain on the area where the cord joins the plug. Roll-A-Seal holds the joined plugs together in the most efficient way possible by friction grip and in their intended position. This invention creates a simple, safe and convenient way to join two or more extension cords together.

### SUMMARY OF THE INVENTION

This invention has taken construction type extension cords and made them safer, more convenient with simple modification in adding a molded latex cover fused to its base so it can be rolled out like rolling down a shirt sleeve onto itself and a joined plug creating a water proof seal and a means to securely hold the joined plugs together until they are unrolled to separate. This invention can save time, lives and money.

### BRIEF DESCRIPTION OF THE DRAWINGS

FIG. 1, number 1 shows the 1/16 inch thick latex sleeve rolled up into itself.

FIG. 1, number 2 shows the female plug of the extension cord not covered by the latex sleeve and not joined to the male plug.

FIG. 1, number 3 shows the male plug of the extension cord not covered by the latex sleeve and not joined to the female plug.

FIG. 1, number 4 shows the 1/16 inch thick latex sleeve rolled up into itself.

FIG. 2, number 5 shows the 1/16 inch thick latex sleeve on the female plug rolled up into itself.

FIG. 2, number 6 shows the male and female plugs joined together with the male latex sleeve rolled out onto and covering both plugs.

FIG. 2, number 7 shows the latex sleeve of the male plug rolled out over itself and onto the female plug covering both of them.

FIG. 3, number 8 shows the latex sleeve of the female plug rolled out over the latex sleeve of the male plug creating a double seal over both the male and female plugs which are joined together.

FIG. 3, number 9 shows the male and female pugs joined together and encapsulated by both latex sleeves.

FIG. 3, number 10 shows the male plug with its latex sleeve covering itself and the female plug and the latex sleeve of the female plug over the male sleeve completing the waterproof seal.

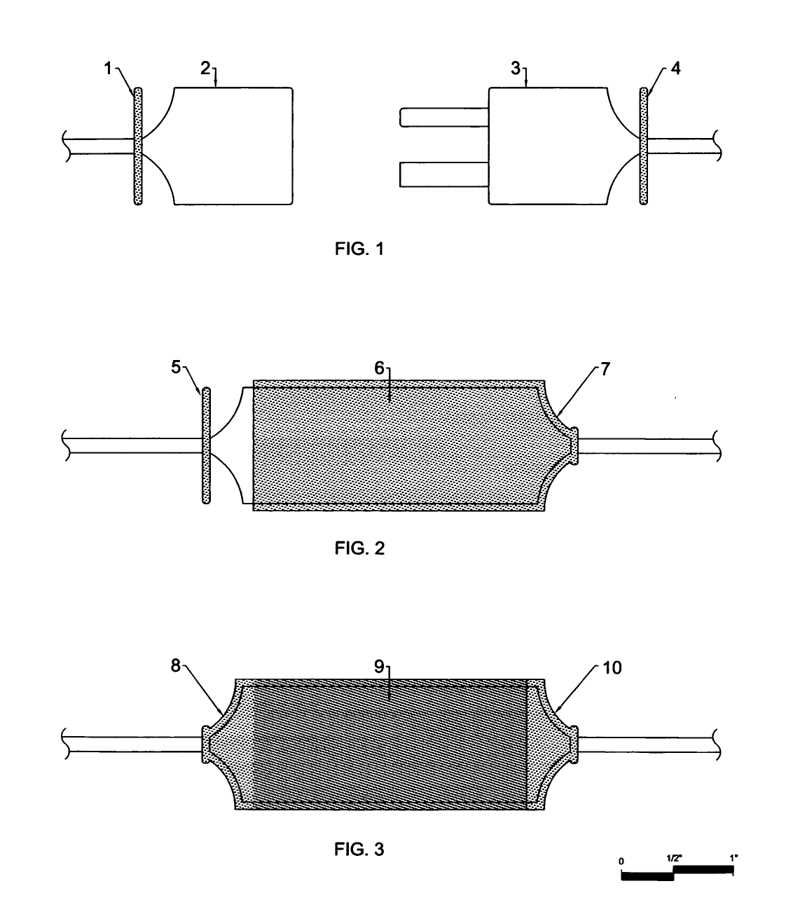

### DESCRIPTION OF THE PREFERRED EMBODIMENT

The shown embodiments illustrated in FIG. 2 indicates the streamlined forward angle of the housing and its elongation allowing less resistance when the marine vessel is moving forward. Also showing the shorter and steeper angle of the rear face of this housing. The steeper rear face will cause more resistance in the water as the vessel is in reverse and this is intentional so a more resistant flow of water is being forced into the diverter area. The triangular shape of the strainer bars shows the least resistance to water entering the housing from either end. Vessels generally are moving much slower in reverse and the steeper angle of the face was necessary in design to create the resisted water flow. The most important aspect of this invention is the curved radius of the diverter plate. With the water pressure buildup inside the scoop housing, the diverter plate literally injects the water through the through hull fitting as shown in FIG. 2. The radius is perfect to create an injection stream instead of perhaps bouncing off a flatter plate or shallower angle. It would be difficult to improve the efficiency of this scoop.

With the location of the diverter plate in relation to the through hull fitting and the curved radius of the diverter plate, the volume of water is actually increased as it is injected into the through hull fitting compared to water that is only being pumped.

What is claimed is:

1. The latex cover which is molded to the base of both male and female plugs on a construction type extension cord, when rolled out on to itself and the connecting plug, creates a waterproof plug connection when joining two or more extension cords together creating a safety factor when used in a wet environment.

2. The latex cover for the extension cord plugs, when rolled out and in place, also helps prevent the separation of the two or more extension cords when they are joined together.

3. The latex cover, when in place, helps prevent corrosion of the metal plug contacts and electrolysis if submerged in water while electric current is moving through the wires.
